(19) United States
(12) Patent Application Publication
(10) Pub. No.: US 2025/0107496 A1
(43) Pub. Date: Apr. 3, 2025

(54) MODULAR HUB SYSTEM FOR PLANT GROWTH ASSEMBLIES

(71) Applicant: Fork Farms Holdings, LLC, Appleton, WI (US)

(72) Inventor: Alexander R. Tyink, Appleton, WI (US)

(73) Assignee: Fork Farms Holdings, LLC, Appleton, WI (US)

(21) Appl. No.: 18/896,499

(22) Filed: Sep. 25, 2024

Related U.S. Application Data
(60) Provisional application No. 63/586,925, filed on Sep. 29, 2023.

(51) Int. Cl. A01G 31/06; A01G 31/00

(52) U.S. Cl. CPC A01G 31/06; A01G 31/065

(57) ABSTRACT

Methods and systems for automated plant production including a primary control hub including a controller, a plurality of plant growth modules, each plant growth module including a secondary hub in communication with and controlled by the primary hub, a plurality of plant assemblies for growing a plurality of individual plants, and a distribution tank in fluid connection with each of the plant assemblies, a plurality of supply tanks containing a supply to support plant growth and a plurality of supply lines, each supply line connecting one supply tank to the distribution tank of each of the plurality of plant growth modules. The primary hub separately controls delivery of each of the supplies to each of the plurality of plant growth modules.

### BACKGROUND OF THE INVENTION

Hydroponic gardening or farming is a popular method of food production that allows for the cultivation of plants in locations and at times of the year when it would not otherwise be possible. Hydroponic systems grow food in a way in which a water nutrient solution is the main form of plant nutrition, as opposed to soil. It can further allow for the efficient use of water through recirculation systems, and for highly controlled growing conditions through the use of artificial lights and controlled delivery of nutrients. In addition, plants can be grown closer to their consumers, allowing for decreased distance of transportation and fresher crops.

Hydroponic farming requires the use of resources including electricity, water, nutrient, manpower, equipment and indoor space, among others. Therefore, in order for it to be cost effective, hydroponic farming methods attempt to minimize the consumption of these resources while maximizing the plant growth and productivity. One method of reducing resource use includes growing hydroponic plants on vertical systems like walls, which allows a much greater number of plants to grown within a particular floor area than horizontal growing methods.

As hydroponic farms become larger to grow crops at scale, the need for efficient and flexible growing systems increases. Various embodiments described herein address these needs.

### SUMMARY

Various embodiments include automated methods of managing plant production systems including indoor plant production systems such as hydroponic systems. Some embodiments include automated plant production system including a primary control hub comprising a controller and a plurality of plant growth modules. Each plant growth module includes a secondary hub in communication with and controlled by the primary hub, a plurality of plant assemblies, each configured for growing a plurality of individual plants, and a distribution tank in fluid connection with each of the plant assemblies. The system further includes a plurality of supply tanks, each supply tank containing a supply to support plant growth, and a plurality of supply lines, each supply line connecting one supply tank to the distribution tank of each of the plurality of plant growth modules. The primary hub separately controls delivery of each of the supplies to each of the plurality of plant growth modules.

In some such embodiments, the supplies include water, one or more nutrient, and/or buffer. The plant assemblies may be hydroponic plant assemblies for growing a plurality of plants in separate wells and an array of lights, such as vertical walls. In some such embodiments, the light cycle of the plant assemblies in each plant growth module is separately controlled by the primary hub.

In some embodiments, the plant growth module further includes a distribution wall, and the distribution tank is located in the distribution wall. The distribution wall provides connectors to each of the plurality of plant assemblies for a flow of water from the distribution tank to the plant assemblies and back to the distribution tank. The system may also include a power supply line connecting to each of the plurality of plant growth modules, and the distribution wall may further provide a power connector for each of the plurality of plant assemblies. In some embodiments, the plant assemblies are vertical walls with plant wells on each side of the wall and an array of lights projecting light onto each side of the wall, and with the plant assemblies arranged in a directly adjacent side-by-side stacked configuration on each side of the distribution wall when connected to the water and power connectors of the distribution wall.

In some embodiments, secondary hub includes a dehumidifier and an HVAC system comprising a heat pump, and the distribution wall includes a duct with vents to supply air to each of the plant assemblies. Each plant assembly may also include a temperature sensor in data communication with the secondary hub, and wherein the primary hub is configured to separately direct each secondary hub to maintain a temperature.

The system may also include a plurality of pumps for the supplies in the supply lines and a plurality of valves, and the primary hub may separately control the delivery of the supplies to each of the plant growth modules by opening and closing the valves.

Other embodiments include automated systems for plant production including a primary control hub including a controller and a water testing device and a plurality of plant growth modules. Each plant growth module includes a secondary hub in communication with and controlled by the primary hub, a plurality of plant assemblies, each configured for growing a plurality of individual plants, and a distribution tank in fluid connection with each of the plant assemblies to supply water and nutrients to the plant assemblies. The system further includes a plurality of supply tanks comprising a water supply tank, a nutrient supply tank, and a buffer tank, a plurality of supply lines, each supply line connecting one supply tank of the distribution tanks of each of the plurality of plant growth modules. The system further includes a water return line running from each of the plant growth modules to the primary hub to supply return water to the water testing device. The primary hub separately controls delivery of each of the supplies to each of the plurality of plant growth modules.

In some such embodiments, the water testing device is a pH testing device, and the primary hub is configured to automatically test the pH of the return water from each of the plurality of plant growth modules on a schedule. The controller may be configured to calculate, for each automatic pH test, the amount of buffer, if any, needed to correct the pH of water in the plant growth module of which the return water was tested. The system may further include a plurality of valves, and the primary hub may separately control the delivery of the supplies to each of the plant growth modules by opening and closing the valves, with the primary hub configured to automatically deliver the calculated amount of buffer to the plant growth module of which the return water was tested.

In some embodiments, the testing device measures an amount of a nutrient, and the primary hub is configured to automatically test the return water from each of the plurality of plant growth modules on a schedule and to calculate the amount of nutrient needed for each plant growth module to maintain the nutrient at a desired level in each plant growth module. In some such systems, the system may include a plurality of valves and the primary hub may separately control the delivery of the supplies to each of the plant growth modules by opening and closing the valves, with the primary hub configured to automatically deliver the calculated amount of nutrient to each plant growth module in need of additional nutrient based upon results of the automatic testing.

Other embodiments include an automated plant production system including a primary control hub comprising a controller and a plurality of plant growth modules. Each plant growth module includes a secondary hub in communication with and controlled by the primary hub, a plurality of plant assemblies, each configured for growing a plurality of individual plants, and a water distribution tank in fluid connection with each of the plant assemblies. The system also includes a plurality of supply tanks including a nutrient supply tank, a water supply tank, and a buffer supply tank, a water supply line connecting the water supply tank to each of the plant growth modules and comprising a water supply valve at each plant growth module, a nutrient supply line connecting the nutrient supply tank to each of the plant growth modules and comprising a nutrient supply valve each plant growth module, and a buffer supply line connecting the buffer supply tank to each of the plant growth modules and comprising a buffer supply valve at each plant growth module. The primary hub is configured to separately control each water supply valve, nutrient supply valve, and buffer supply valve to separately regulate the flow of water, nutrient, and buffer to each plant growth module.

In some such systems, the system also includes a water return line connecting each plant growth module to the primary hub, and the primary hub further includes a pH testing device and a nutrient testing device configured to receive return water from each plant growth module in the water return line. The primary hub separately regulates the flow of nutrient and buffer to each plant growth module based on results from the pH testing device and the nutrient testing device. In some embodiments, the water distribution tanks of each plant growth module include a water level sensor in communication with the primary hub, and the primary hub is configured to automatically and separately supply water to each plant growth module in response to the water level sensor to maintain a predetermined water level in each water distribution tank.

### BRIEF DESCRIPTION OF THE DRAWINGS

While the specification concludes with claims particularly pointing out and distinctly claiming the subject matter that is regarded as forming the various embodiments of the present disclosure, it is believed that the disclosure will be better understood from the following description taken in conjunction with the accompanying Figures, in which:

FIG. 1 is a representative diagram of a modular plant growth system according to various embodiments;

FIG. 2 is a representative diagram of a primary hub for use in a modular plant growth system according to various embodiments;

FIG. 3 is a representative diagram of a secondary hub and distribution wall for use in a modular plant growth system according to various embodiments;

FIG. 4 is an example of a distribution wall and secondary hub according to various embodiments;

FIG. 5 is an example of an alternative embodiment of a distribution wall and secondary hub according to various embodiments;

FIG. 6 is a representative example of a distribution wall and a secondary hub according to various embodiments;

FIG. 7 is a perspective view of an example of a plant assembly according to various embodiments;

FIG. 8 is partial view of a drain of the plant assembly of FIG. 7 according to various embodiments;

FIG. 9 is a side view of the plant assembly of FIG. 7 according to various embodiments;

FIG. 10 is an end view of the plant assembly of FIG. 7 according to various embodiments;

FIG. 11 is a top view of the plant assembly of FIG. 7 according to various embodiments;

FIG. 12 is a perspective view of the frame of the plant assembly of FIG. 7 according to various embodiments;

FIG. 13 is a photograph of a plant assembly according to various embodiments;

FIG. 14 is a front perspective view of the support of the plant column of the plant assembly of FIG. 7 according to various embodiments;

FIG. 15 is a back perspective view of a plant column of the plant assembly of FIG. 7 according to various embodiments;

FIG. 16 is a front perspective view of a plant column of the plant assembly of FIG. 7 according to various embodiments;

FIG. 17 is a top view of the support of FIG. 14 according to various embodiments;

FIG. 18 is a front view of a plant panel of the plant assembly of FIG. 7 according to various embodiments;

FIG. 19 is a side view of the plant panel of FIG. 17 according to various embodiments;

FIG. 20 is a perspective view of a cap of a plant column of the plant assembly of FIG. 7 according to various embodiments;

FIG. 21 is a top perspective view of the reservoir of the plant assembly of FIG. 7 according to various embodiments;

FIG. 22 is a top view of a reservoir cover of the plant assembly of FIG. 7 according to various embodiments; and

FIG. 23 is a top perspective view of the reservoir cover of FIG. 22 according to various embodiments;

FIG. 24 is a top perspective view of the reservoir aperture plug of the plant assembly of FIG. 7 according to various embodiments; and

FIG. 25 is a side view of the reservoir aperture plug of FIG. 24.

### DETAILED SUMMARY OF THE INVENTION

The following detailed description is exemplary in nature and is not intended to limit the scope, applicability, or configuration of the invention. Rather, the following description provides practical illustrations for implementing various exemplary embodiments. Utilizing the teachings provided herein, those skilled in the art may recognize that many of the examples have suitable alternatives that may be utilized.

Various embodiments include systems which include a primary hub connected to a plurality of plant growth modules, each plant growth module including a secondary hub connected to a distribution wall, which is in turn connected to a plurality of associated plant assemblies in close proximity to and connected to the distribution wall. The plant assemblies may be vertical plant growing wall structures or other hydroponic plant growing structures containing a plurality of growing plants. Water, nutrients, buffer, power and other plant assembly needs maybe supplied from the primary hub to each of the plant growth modules. In addition, the primary hub may perform diagnostic tests related to the status and functioning of the plant assemblies in a centralized manner, and the primary hub may control the separate delivery of water, nutrient, buffer, power and other plant assembly needs to each of the individual plant growth modules according to instructions input by a user as well as the results of centralized testing. In addition, the system allows for customization of a plant growth system to fit into any space in a modular manner, as the number of, and the locations of the plant growth modules can be modified as needed. At the same time, it allows for a single source of plant assembly needs (water, power, nutrients, buffer, etc.) to be centrally located and supplied to the system and then distributed to the numerous plant assemblies as needed. These plant assembly needs (water, power, nutrients, buffer, etc.) may be generally referred to herein as supplies.

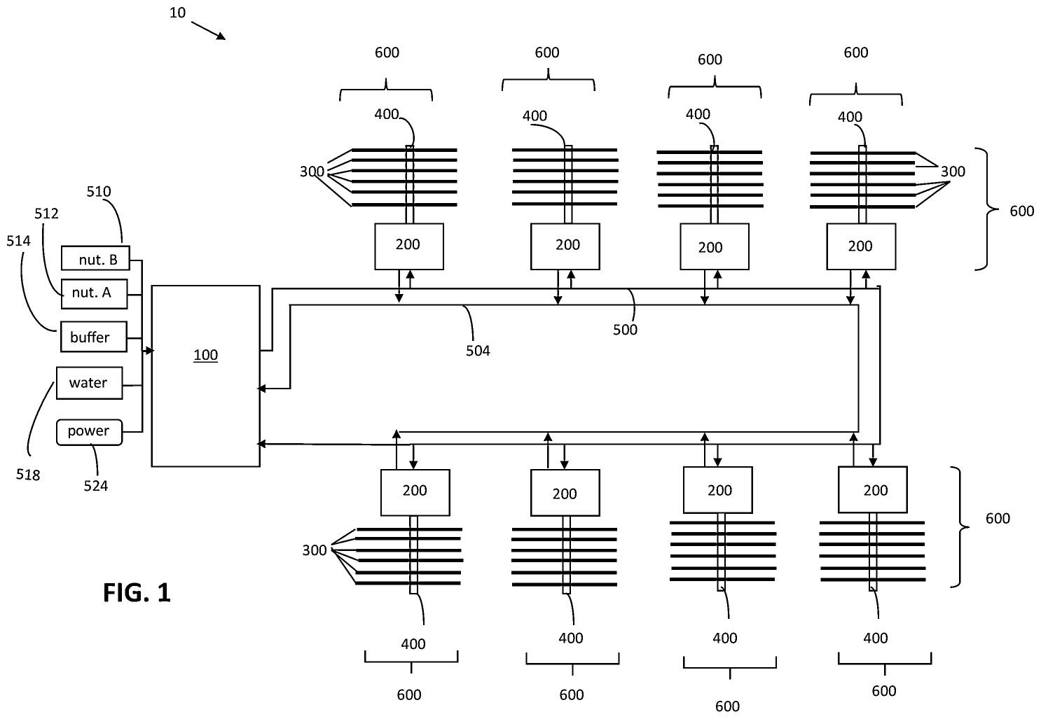

A simplified schematic of a plant growth system according to various embodiments is shown in FIG. 1. The system 10 includes a primary hub 100 and a plurality of plant growth modules 600 in connection with the primary hub. Each plant growth module 600 includes a secondary hub 200, a distribution wall 400, and a plurality of plant assemblies 300. A supply line bundle 500 transports the supplies from the primary hub 100 to the plant growth modules 600. Although the supply line bundle 500 is shown as a single line, this is for ease of depiction and the supply line bundle 500 may comprise a plurality of separate lines including a plurality of supply lines 502, power lines 503, and data lines 501 each transporting a different supply. For example, the power lines 503 may include separate power lines extending from the primary hub 100 to each secondary hub 200. These supply lines 502, power lines 503 and data line 501 of the supply line bundle 500 may run together, such as in a bundle, or in close proximity, for ease of installation, or portions or all of the lines may run separately and may not actually be a physical bundle. The supply line bundle 500 may transport the supplies in a serial manner to a first plant growth module 600, then to a second plant growth module 600, then to a third plant growth module 600, etc., consecutively, until supplying all plant growth modules 600 as shown in FIG. 1, with the supply line bundle 500 terminating at or immediately after the last plant growth module 600. In alternative embodiments, the supply line bundle 500 may include one or more branches to provide supplies to multiple plant growth modules 600 in a parallel manner, or in a combination of a serial and parallel configuration. In addition, in other embodiments, a single primary hub 100 may provide supplies through more than one supply line bundle 500, such as two or three supply line bundles 500, which may each transport supplies to a plurality of plant growth modules 600. The flexibility of the system 10 allows for any of these configurations. The supply lines bundle 500 may include electrical power supply lines and conduit, pipes, data lines, etc. as appropriate for the type of supply. In addition, there may be a plurality of valves in the primary hub 100, secondary hubs 200, in the source supply lines 526 and/or the supply lines 502 and/or their branches to control the distribution of each supply, such as liquid supplies (water, nutrient, buffer) to each plant growth module 600, as described further later in this disclosure. For example, valves 506 in the source supply lines control the delivery of the supply from the supply tanks to the primary hub 100 and are under the control of the primary hub 100. The valves used throughout the system may be controlled by the primary hub 100, which opens and closes the valves to direct flow of the supplies and of the return sample water as needed as determined by the primary hub 100. from the supply tanks to the primary hub 100 and then to the secondary hubs 200, with the valves 506 controlled by the primary hub 100. In addition, there may be a flow meter present at some or all of the valves used in the system 10, in communication with the primary hub 100, enabling the primary hub 100 to monitor how much supply has passed through the valve to then close the valve when the determined amount of supply or return sample water has passed through the valve. The primary hub 100 similarly controls the lights through the delivery of power, as well as many other aspects of the system 10, as will be discussed later.

The system 10 further includes a return line 504. The return line 504 transports water from each plant growth module 600 to the primary hub 100 where the returned sample water can be tested. Like the supply line bundle 500, the return line 504 may transport returned sample water along a single pathway from each plant growth module 600 in a serial nature as shown, or alternative though parallel lines, or through a combination of serial and parallel lines. Based on the test results of the returned sample water from a particular plant growth module 600, the primary hub 100 may adjust its delivery of supplies to that plant growth module 600. For example, if the primary hub 100 detects a pH imbalance in a particular plant growth module 600, it may calculate the necessary amount of buffer needed to correct the pH. It may then automatically send that amount of buffer by opening the valves along the buffer supply line that supply that plant growth module 600 to correct the pH, and then close the valves when the calculated amount of buffer has been delivered. Likewise, if the primary hub 100 detects a lack of a nutrient in a particular plant growth module 600, it may calculate the necessary amount of nutrient needed to correct the nutrient level and send that appropriate amount of nutrient through the corresponding nutrient supply line by opening the valves in that line for the amount of time needed to deliver the calculated amount of nutrient, and then closing the valves.

Although not fully shown in the Figures, the supply lines 502 may extend to each plant growth module 600 and then circle back to their corresponding supply tank. In this way, each supply (water, nutrient, and buffer, for example) circulates through a loop to each plant growth module 600, under the pressure of pumps, with the circulation and the supply delivery controlled by the primary hub 100 by opening and closing valves within the loop.

Each secondary hub 200 is associated with a single distribution wall 400 and a plurality of plant assemblies 300, together forming a plant growth module 600. The secondary hub 200 acts as a point of connection to the primary hub 100 and further connects to the distribution wall 400. The secondary hub 200 includes controllers to carry out instructions received from the primary hub 100. That is, the secondary hub includes the native control systems to control the local environment within the parameters as directed by the primary hub 100. For example, the secondary hub 200 includes the controllers to enact the instructions received from the primary hub 100 to control the temperature by heating and cooling such as through a heat exchanger, as well as the ambient air velocity and the humidity. In addition, the secondary hub 200 includes a power relay, controlled by the primary hub 100, to control the light cycle of the lights in the plant growth module 600. The distribution wall 400 also acts as a point of direct connection to the primary hub 100 as well as centralized distribution to the plant assemblies 300.

Although this example shows eight plant growth modules 600 connected to and supplied by the primary hub 100, the systems 10 are flexible and may include more or less than 8 plant growth modules 600 per primary hub 100. For example, the system 10 may include a single primary hub 100 connected to a plurality of plant growth modules 600 such as between 2 and 20 plant growth modules 600, or between 3 and 15 plant growth modules 600 or between 3 and 10 plant growth modules 600. In very large plant growing facilities, the system may include more than one primary hub 100, each primary hub 100 connected to a plurality of plant growth modules 600 as described herein, with each primary hub 100 and associated plant growth modules 600 arranged in any configuration convenient to fit within the space, such as within a single large room or building or warehouse. For example, while FIG. 1 shows the arrangement of plant growth modules 600 arranged in a U-shaped loop configuration, they could instead be arranged in a straight line or any other configuration, depending upon the available space, making the system 10 very flexible. The system 10 is further flexible with regard to the number of plant growth modules 600, such that the system 10 can be expanded to include additional plan growth modules 600, or plant growth modules 600 can be removed from the system or replaced, at any time as desired. In addition, the particular plant assemblies 300 used in a particular plant growth module 600 can be removed and/or replaced at any time, or the plants grown in particular plant assemblies 300 can be removed, replanted, or changed at any time. In addition, other plant growth systems may be connected to the system to be supplied by and/or controlled by the primary hub 100, such as other types of hydroponic growing walls or systems, plant germination systems, etc. Plants germinated and grown in a plant germination system included in the system 10 may be supplied with supplies (water, nutrients, buffer, power, etc.) by the same primary hub 100 as the plant growth modules 600 and may be transplanted to the plant assemblies 300 of the same system 10 at the appropriate time in the plants' growth.

In use, the plant growth systems 10 described herein provide many benefits. For example, by using a primary hub 100 connected to a plurality of plant growth modules 600 each including a plurality of plant assemblies 300, the primary hub 100 can take over functions that might otherwise need to be performed by each of the plant assemblies 300. In this way, some functions and equipment can be centralized at the primary hub 100, avoiding redundancy, lowering costs, and making the process more efficient and easier to operate. For example, in some embodiments, the water which is supplied to the plant growth modules 600 may be reverse osmosis water. This water may be treated and stored in a central location, for distribution by the primary hub 100 to each of the plant growth modules 600 and their included plant assemblies 300. Likewise single sources of nutrients, buffers, and any other supplies may be supplied to all of the plant growth modules 600 through the primary hub 100 and under the control of the primary hub 100. Furthermore, the centralized testing allows for a single testing set of equipment of a particular type to be used in the primary hub 100, which can test the water of each plant growth module 600 without the redundancy of having testing equipment at each plant growth module 600 or each plant assembly 300, and without the need to manually obtain samples from each plant assembly 300. In addition, the centralized control provided by the primary hub 100 allows for the supplies provided to each plant growth module 600 to be easily, immediately and automatically adjusted as needed, without manual input or delivery, depending upon the results of the automated testing by the primary hub 100. In addition, the customizable system can separately provide the needs of various plant growth modules 600 which may vary, such as depending upon the type of plant being grown or the life stage of the plant, which may be different in different plant growth modules 600.

Another benefit of the system 10 including a primary hub 100 connected to a plurality of plant growth modules 600 is ease of installation. For example, connections to services such as electricity and water can be made for supplying the primary hub 100 only, with no additional direct service connections to the plant growth modules 600 or their plant assemblies 300. Rather, the services can be distributed to each of the plant growth modules 600 and their plant assemblies 300 only from the primary hub 100.

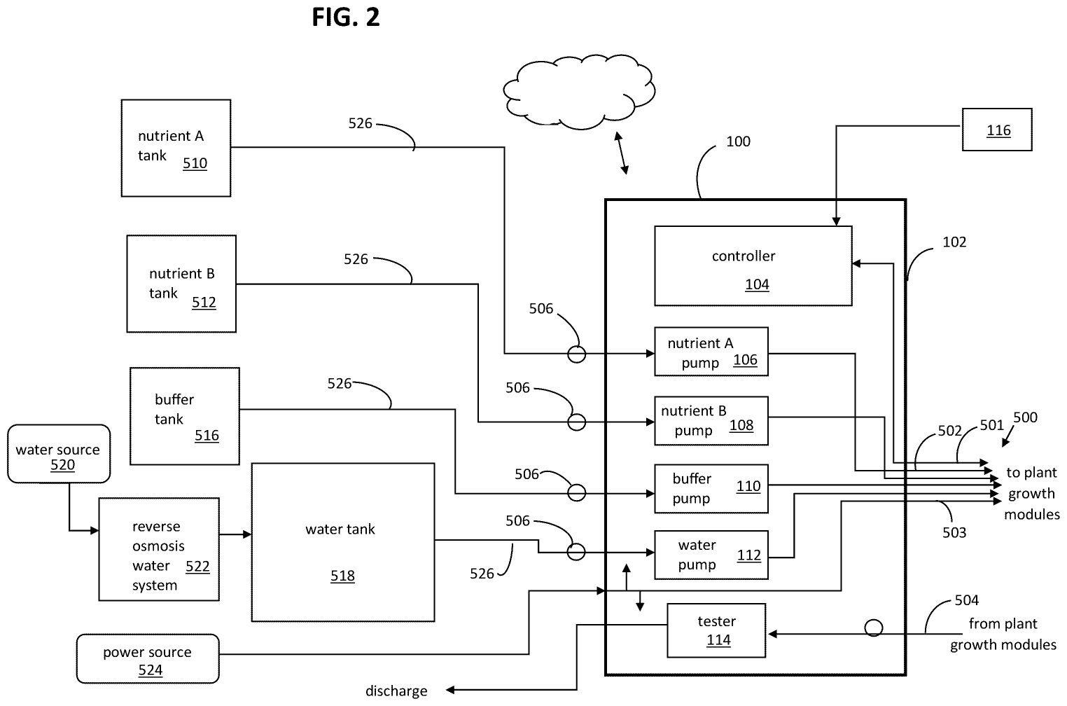

A more detailed example of a primary hub 100 is shown in FIG. 2. The primary hub 100 may include a rigid housing 102 which encloses some or all of the components of the primary hub 100, with internal supports for the components. In other embodiments, the primary hub 100 may include a rack with shelves which support the components of the primary hub 100 without an outer housing. There may be a plurality of inlet ports and outlet ports in the housing 102 or elsewhere for connection to input lines and output lines as described further below. Components of the primary hub 100 may include a controller 104, a plurality of pumps, and testing equipment 114. The controller 104, and other controllers described herein, may include one or more processors and one or more memory components. For example, the one or more processors may be configured to store and execute instructions such as software for the operation of the primary hub 100, and one or more memory devices for storage of software and data such as data related to the plant growth modules 600 such as plant growth module growing needs and parameters (such as nutrient and pH levels, light cycle) and water test results. The controller 104 may include digital electronic circuitry of various types including integrated circuits, hardware, software, and/or other components in various combinations. It may include machine readable medium such any type of memory which may be used to provide machine instructions and/or data to a processor, which may implement the methods described herein using one or more computer programs. The machine readable medium may store machine instructions in a non-volatile or non-transient manner (such as in a solid state medium) and/or in a transient manner (such as in a cache or random access memory). For example, the controller 104 may include one or more processors for processing and one or more memory components. The processor may be configured to execute programming to perform the various steps described herein. The memory may store data such as plant growth module water testing data. The memory may further store programs such as an operating system and one or more application programs which operate on the processor. The controller 104 may further have components for transmission of data, such as a data port like a USB connection and/or other data connection, or components for wireless connection such as blue tooth, Wi-Fi, and/or other data transmission components, such as for communication with the cloud as shown in this example. In addition to communicating data related to operations, the controller 104 may also send emergency alerts to an operator, as discussed further below, such as by using any of these data transmission methods. In critical situations such as temperature, humidity, or carbon dioxide being above or below a permitted value, or the presence of water on the floor, the controller 104 may send the operator an emergency alert notification by email or text or a notice within a system app, for example.

The controller 104 may connect to a source of power through a plug for connection to a power cord or may include a cable or power cord for connection to a power source and may optionally include an internal battery such as a rechargeable battery for continued power supply in the event of a loss of external power. In various embodiments, all power for the system 10 is provided through a single power connection, such as single electrical panel. The primary hub 100 and each secondary hub 200 may include electrical subpanels that all connect to and receive power from the same single electrical panel. For example, the single electrical panel source of power may be provided by a customer, and the system 10 may connect to it, or it may be a component of the system 10.

The primary hub 100 includes a plurality of pumps for pushing the supplies such as liquid supplies through the supply lines 502. In the example shown in FIG. 2, the primary hub 100 includes a separate pump for each of various supplies including pump 106 for nutrient A, pump 108 for nutrient B, a buffer pump 110, and a water pump 112. Other supplies controlled and supplied via the primary hub 100 may likewise be connected to a dedicated pump in the primary hub 100. Each of the supply pumps 106 108 110 112 transmit a supply through a separate supply line 502, one for each supply, that connects to all of the plant growth modules 600 in the system 10, such that the supplies in the supply lines 502 to the plant growth modules 600 are under pressure. The primary hub 100 controls each of the valves 532 in the supply line branches 530 from the supply lines 502 to the plant growth modules 600 and elsewhere in the system 10. In this way, when the relevant valve 532 is opened by the primary hub 100, the supply flows through the supply line 502 and supply line branch 530 specifically to the selected plant growth module 600 under the force created by the pump of the primary hub 100.

As shown in FIG. 2, each of the pumps 106 108 110 112 is connected to a supply source such as a tank, reservoir or other type of storage container. In this example, the supply sources include a nutrient A tank 510, a nutrient B tank 512, a buffer tank 516, and a water tank 518. One source supply line 526 from each tank connects the tank to its pump in the primary hub 100. In this way, only a single tank of each supply needs to be maintained and replenished, rather than a plurality of tanks for each of the plant growth modules 600 or each plant assembly 300, greatly simplifying the plant growth operation. In this example, the water supplied to the water tank 518 is reverse osmosis water, or RO water. Therefore, water is provided to the system 10 from a single connection to a water source 520 such as municipal water or well water, which is then processed by a single reverse osmosis treatment system 522 and then supplied to the water tank 518.

The primary hub 100 further includes a power inlet or power cord for connection to a power source 524. The primary hub 100 includes the necessary wiring to supply power to the controller 104 and the pumps for their operation and control. The power is further passed from the primary hub 100 as a supply in the power line 503 of the supply line bundle 500 to provide power to each of the secondary hubs 200, the lights of the plant assemblies 300, the distribution walls 400, and the valves 532 in the supply line branches 530 and other valves throughout the system 10.

The primary hub 100 may further include one or more testing devices such as water testing devices 114. A water inlet in the primary hub 100 connects to the return line 504 delivering water from each of the plant growth modules 600. The water inlet is connected to tubing in the primary hub 100 which delivers water to the one or more testing devices 114 under the control of the controller 104. Examples of water testing devices 114 which may be used in various embodiments include pH measuring devices and nutrient measuring devices such as electrical conductivity detectors to measure total dissolved solids. Other testing devices 114 that may be used include devices which test for biofilm levels, microbiology levels, cleaning solution levels, hormones and/or enzyme levels, and scale build up. The testing device 114 may include a return water collection container which functions as a testing pot and probes with detection ends in the testing pot. The probe may detect electrical conductivity to determine the total dissolved solids in the return water. Because the testing device 114 is centralized and used for measuring water samples from many different plant growth modules (rather than including a testing device at each plant growth module 600 or plant assembly 300) a higher quality testing device 114 may be used. For example, the testing device 114 may be industrial, pharmaceutical or laboratory grade, rated for anti-corrosiveness for use in high humidity and high salt environments as may occur in the return water which includes the nutrients. After the return water is tested by the testing device 114, it may be discarded through a drain line to a drain.

The water in the return line 504 is under pressure from water pumps 422 in the plant growth modules 600 such that, when the valve 534 in the return line branch 536, from the plant growth module 600 to the return line 504, is opened by the controller 104, the water may flow passively through the return line 504 to the testing device 114. From the timing of the opening and closing of individual valves 536 and the known flow rate of water through the return line 504 and thus the known transit time of water from each plant growth module 600, the controller 104 can determine which plant growth module 600 is the source of the water arriving at the testing device 114 at any time particular time and can collect and test the water from a selected individual plant growth module 600 based upon its determination of the specific plant growth module 600 that is the source of the returned water. The primary hub 100 further includes a discharge outlet for discharging the returned water after testing and/or for discharging untested returned water.

In addition to controlling the secondary hubs 200, the primary hub 100 may also manage the grow room facility as a whole, such as by monitoring and responding to conditions. For example, one or more sensors 116 may send sensed data to the controller 104. These sensors 116 may be located remote from the primary hub 100 to detect certain conditions in the grow room. Examples of sensors 116 which may be used in various embodiments include carbon dioxide sensors and humidity sensors, one or more of which may be located at various positions in the grow room, such as suspended from the ceiling. In response to data from these sensors 116, the controller 110 may direct the secondary hub 200 to make a correction. For example, humidity data sensed by the sensors 116 may be used by the controller 104 to determine whether or not adjustment of the dehumidification systems at the secondary hubs 200 is required. If the controller 104 determines that humidity levels are too high, such as based on preset parameters or parameters provided by an operator, then the controller 104 may direct the secondary hubs 200 to increase activity of their dehumidifiers.

Sensors 116 may also be used to regulate carbon dioxide levels in the grow room. When sensors 116 are carbon dioxide detectors, the carbon dioxide level data is provided to the controller 104, which determines whether the carbon dioxide levels are within predetermined parameters, such as preset parameters or parameters provided by an operator. When carbon dioxide levels rise above a set threshold, the controller 104 signals the air handling unit to introduce more fresh air into the grow room. In other embodiments, additional carbon dioxide may be provided by a source of stored carbon dioxide.

In some embodiments, the parameters which are monitored by the controller 104 include the temperature, with data temperature data received from sensors 230 at the plant growth modules 600, though the temperature data could alternatively be received directly from sensor 116. These parameters may include an emergency cut off value, which may be preset or input by an operator. When the sensors 116 detect that the temperature exceeds an emergency threshold value, such as if the temperature in the grow room exceeds the emergency threshold value at any time, or for a time greater than a threshold period of time, the controller 104 may initiate an emergency response. For example, the air handling system may be configured to not only provide air but also to remove air from the grow room. The controller 104 may automatically engage the air handling system to evacuate air from the grow room and replace it with fresh air. It may further automatically send an alert to the operator to notify that operator that an emergency air evacuation has occurred. This rapid response may prevent damage to or death of the plants in the grow room. Likewise if the sensors detect that humidity is too high, the controller 104 could automatically engage an emergency purge of the room air.

In some embodiments, the system may include sensors 230 at the plant growth modules 500, such as water detectors which may be located on the floor of the grow room to detect the presence of water or to detect the presence of water of certain amount or depth. For example, the water detectors may be located at various locations, such as on the floor underneath each plant growth module 500 and/or in other locations. These sensors 230 may send data to the controller 104. If water is detected on the floor, or if water of a certain level is detected on the floor, the controller 104 may automatically send an emergency alert to the operator to notify the operator of a possible leak.

Although not shown, the primary hub 100 may include one or more user interfaces (such as a display screen, a touch screen, a keyboard, mouse, etc.) which allow an operator to communicate with the controller 104, such as to input data and receive data. Alternatively or additionally, the primary hub 100 may include one or more data ports such as a USB, ethernet, or other data connections, such as for connection to a user interface such as a computer, tablet, or other portable electronic device. In some embodiments, the primary hub 100 may, alternatively or additionally, be configured to allow remote communication with an operator, such as through the internet or the cloud using wired or wireless communication. In such embodiments, the primary hub may include data connection ports for connection to the internet or may include hardware for wireless connection to the internet. In such embodiments, an operator may communicate with the system through a website, an app, or other methods, and the operator may be located remote from the grow room. Such embodiments may be particularly useful for automatically sending alerts, such as emergency alerts, to the operator.

The controller 104 may include stored data and instructions such as preset parameters or parameter ranges for operating variables (or allowed ranges of variables) to be maintained such as temperature, humidity, nutrient levels, pH, carbon dioxide levels and light cycles, which may be generic and/or may depend upon other variables, such as the type of plant being grown and its growth stage, which may be entered by an operator. The controller 104 may automatically apply one or more present parameters and/or one or more parameters may be entered by an operator or may be modifiable by an operator. The operator may enter type of plant being grown in each plant growth module 500, and the controller 104 may automatically apply one or more stored preset parameters based on the input information or may present one or more proposed parameters to an operator based on the input information for the operator to select.

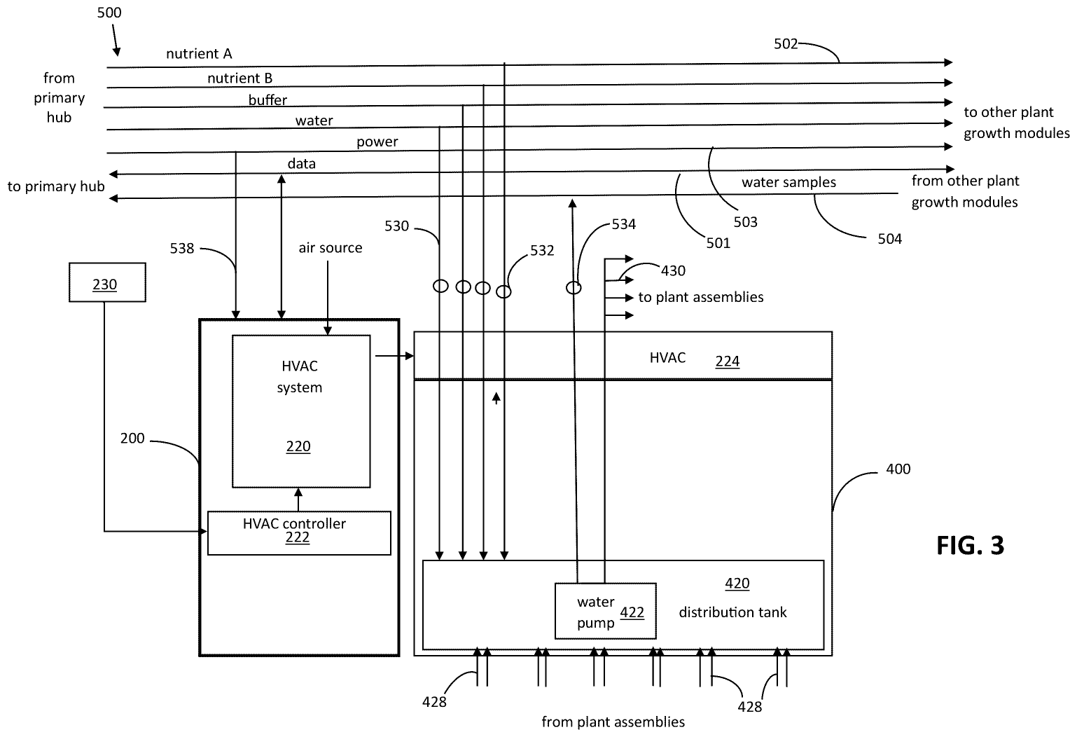

A more detailed example of a secondary hub 200 is shown in FIG. 3. The supply lines 502, power line 503 and data line 501 in the supply line bundle 500 pass supplies, power and two way data transmission to the secondary hub 200 and/or distribution wall 400 of the plant growth module 600, providing supplies and then proceeding to the next plant growth module 600. The supply line bundle 500 may extend from the primary hub 100 to each of the plant growth modules 600 though a pathway which is suspended from the ceiling, such as in a tray system, to avoid causing obstruction. Each supply line 502 includes a branch at each plant growth module 600 to form a supply line branch 530 to transport the supply to each distribution wall. Alternatively, the supply line branch 530 could connect to the secondary hub 200, and then flow through to the distribution wall 400. Each supply line branch 530 further includes a valve 532 under control of the primary hub 100. As mentioned above, the supplies within the supply lines 502 are under pressure from the supply pumps 106 108 110 112 in the primary hub 100. The supply lines branches 530 which branch from the supply lines 502 are likewise under pressure, such that when a valve 532 in a supply line branch 530 is opened by the primary hub 100, the supply flows to the plant growth module 600 where it flows into the distribution tank 420. In this way, each of the supplies is provided from a central stock tank, through the primary hub 100 then through a supply line 502 with supply line branches 530 to each plant growth module 600, with the amount of supply provided to each plant growth module 600 separately and individually controlled by valves 532 controlled by the controller 104 in the primary hub 100. The controller 104 determines the amount of each supply required by each plant growth module 600 and distributes the determined amounts to the distribution tanks 420 through activation of the valves 532 to open and close the flow through the supply line branch 530 for the necessary amount of time, depending upon the known flow rate, to deliver the determined amount of the supply. The amount of each supply delivered to each plant growth module 600 may depend upon the results of water testing performed by the testing device 114 of the primary hub 100 and/or the needs of the particular type of plant being grown in each plant growth module 600. As such, depending upon the known needs of particular plant, such as the balance of nutrients and the pH, as well as the test results, the controller 104 may determine how much of each supply must be provided to each plant growth module 600.

In some embodiments, the primary hub 100 may control a continuous testing process. A water sample is obtained from a first plant growth module 600 by opening the relevant valves and waiting for the return water from the first plant growth module 600 to pass to the testing equipment where it is tested. Return water that passes to the primary hub 100 in advance of the water to be tested may be discharged. A return water sample may then be obtained from a second plant growth module 600 by opening the relevant valves and again waiting for the return water sample from the second plant growth module 600 to pass to the primary hub 100, disposing of the unneeded water remaining in the return lines 504 from the first plant growth module 600. The return water sample from the second plant growth module 600 is then tested by the primary hub 100. The process of taking samples from each plant growth module may continue consecutively until return water is tested from each plant growth module 600 and may then begin again by obtaining a return water sample from the first plant growth module 600. During this testing, if a problem is noted with the water sample from a plant growth module 600, the primary hub 100 directs the delivery of the appropriate supply to that plant growth module 600 to correct the problem. During the subsequent cycle of sampling and testing of return water from that plant growth module 600, the primary hub 100 can detect whether or not the problem was corrected by the supply that was provided to that plant growth module 600. In addition, the controller 104 of the primary hub 100 can control the frequency of testing, such as continuously, or once a day, or twice a day (such as morning and night), and this testing frequency may be input into the system 10 by an operator.

The amount of water present in each plant growth module 600 is also regulated. A distribution tank 420 provides a centralized reservoir of water for all of the plant assemblies 300 in the plant growth module 600. A water level sensor in the distribution tank 420 detects when the water level in below a preset desired level. When a low water level is detected by the water level sensor, the controller 104 of the primary hub 100 automatically directs delivery of additional water to that distribution tank 420.

The type of plant being grown in each plant growth module 600 may be input into the controller 104 by a user. The needs of that plant (concentrations of nutrients, light cycle, pH, etc.) may also be input by a user, or those needs may be already known and stored in a database in the memory of the controller 104, and/or the information in the database may be optionally modifiable by a user. Different types of plants may be grown in different plant growth modules 600, and the controller 104 can vary the amount of supplies provided to each plant growth module 600 according to the plant needs of each plant growth module 600, with different amounts of supplies provided to different plant growth modules 600 to maintain different pH levels, different concentrations of nutrients, and/or different light cycles.

As shown in FIG. 3, each of the supply line branches 530 delivers a supply (such as nutrient A, nutrient B, buffer, and water) to the distribution tank 420 in the distribution wall 400 associated with the secondary hub 200 and plant assemblies 300 (not shown). A water pump 422 in the distribution wall 400 pumps water, containing the correct maintained balance of nutrients, etc. as supplied by the primary hub 100, out of the distribution tank 420 through an irrigation manifold 426 (not shown) to a plurality of supply lines 430 for delivery to each of the associated plant assemblies 300. The water pump 422 also pumps water through a sample branch line 536 to the return line 504. In FIG. 3 the supply lines 430 and the sample branch line 536 are shown as separate lines from the water pump 422, but they could alternatively originate together as a single output line from the water pump 200 which subsequently branches into the two or more or multiple separate lines. Likewise each of the supply lines 430 could originate as separate lines from the irrigation manifold 426, or they could originate as a single line that subsequently branches into a plurality of lines. Each supply line 430 delivers water, nutrients, and buffer to one of the plant assemblies 300 included in the plant growth module 600. In this example, there are six supply lines 430 shown extending through the distribution wall 400, to supply two irrigation lines for each plant assembly 300 on one side of the distribution wall 400, though other numbers of supply lines could alternatively be used, depending, for example, on how many plant assemblies 300 are being supplied. Other branching arrangements of the water supply may alternatively be used, and other systems of water distribution may alternatively be used as an alternative to or in addition to the manifold 426. A plurality of water return lines 428 connect to the distribution tank 420 within the distribution wall 400, with one water return line 428 passively returning the supplied water from each of the plant assemblies 300 to the distribution tank 420 by gravity. Large debris present in the reservoirs or each plant assembly 300 may be filtered out, such as by a filters in the plant assembly such as a filter directly before the water return line 428. Additional filters may be present in the distribution wall 400. For example, an in line filter such as a basket strainer may be present in the irrigation line, such as between the pump 422 and the manifold 426.

The secondary hub 200 also includes an HVAC system 220 and an HVAC controller 222 for suppling temperature regulated air to the plants. The HVAC system 220 may include a heat pump which heats and cools the air, an air handling unit for blowing the air, and an air humidifying unit. The HVAC system 220 may be connected to an external air handling unit which provides an external source of fresh air through venting to the outdoors, such as through ducts connected to an air intake in the exterior wall or through the roof of the of the location containing the system 10. An HVAC duct 224 extends from the secondary hub 200 along the top of distribution wall 400, with a plurality of output vents, with an output vent located above and between the proximal ends of each plant assembly 300, for example.

The heat pump of the HVAC system 220 includes a heat exchanger, and any type of heat exchanger may be used. In some embodiments, the heat exchanger may include a heat pump fan coil on or within or in proximity to the secondary hub 200 and a refrigerant line that runs to a remote condensing unit which may be located outside, such as adjacent to the building or facility or on the roof. The heat pump efficiently heats and cools the air in the vicinity of the plant growth module 600.

In addition to the HVAC system 220 located at each secondary hub, the system 10 may further include a separate air handing unit for maintaining the air in the entire grow space, such as the room or facility, at appropriate levels of carbon dioxide and humidity. The air handling unit may be located outdoors, such as adjacent to the building or facility or on the roof and may include ductwork and vents to supply fresh air to the grow space to replenish carbon dioxide or to adjust the humidity, for example. The air handling unit may include a heat pump to pretreat the air (heat or cool the air) before it is released into the grow space, so that less energy is required by the HVAC systems 220 at each plant growth module 600 to maintain the desired grow temperature.

When carbon dioxide levels are low, the external air handling unit may replace the air in the grow facility using fresh external air and without directly inputting carbon dioxide from a concentrated carbon dioxide source. However, the temperature of the external air is often not appropriate for use in the growing facility. The heat exchanger of the air handling unit pre-treats the incoming air, using the air that is present in the facility, to bring it up (or down) to, or closer to, the desired air temperature in the facility. By pretreating the air using the heat pump, less energy is required to heat or cool the air inside the facility and the energy is recaptured. As a result, the system 10 is more energy efficient because less energy is required to maintain the facility, which results in a cost savings.

Sensors 230, such as temperature sensors, may be located at each plant growth module 600, such as between one or more plant assemblies 300 or in proximity to the plant assemblies 300. These sensors 230 may relay their readings to the HVAC controller 222 in the secondary hub 200, which responds by adjusting its function to regulate the temperature as directed by the primary hub 100. The HVAC system 220 is integrated with and controlled by the controller 104 of the primary hub 100, which directs the functioning of the HVAC system 220 and dehumidifier to maintain set parameters such as temperature, carbon dioxide levels, and humidity level. These parameters, in turn, may be input into the primary hub 100 by an operator. In this way, the primary hub 100 controls and maintains the environment at each plant growth module 600 through the sensors 230 (as well as the sensors 116 that communicate directly with the controller 104) and the HVAC systems 220 at each secondary hub 200.

The secondary hub 200 may also include other components for local control of the plant growth module 600, such as a dehumidifier and electrical subpanels or relays. The electrical subpanels may include high and/or low voltage. For example, the secondary hub 200 may include a high voltage panel as a power control panel and a low voltage panel as an automation control panel. The power control panel may relay power to the lights, the pump 422, the HVAC components, and the dehumidifier, for example. The automation control panel may control the solenoid valves. The automation panel may include sensor data/flow data and the high and low voltage panels may be connected to allow for communication, such as so that the grow light and pump can communicate with the primary hub 100. All of these components may be individually controlled through an interface tied to the primary hub 100 which provides the primary control, while the native controls of the HVAC, dehumidifier, etc. are provided by the secondary hubs 200. In addition, separate power lines may run from the primary hub 100 to each secondary hub 200.

Like the supply lines 502 for the other supplies, the power line 503 which provides power from the primary hub 100 includes power line branches 538 at each plant growth module 600 to provide power to the secondary hub 200, pump 422, and the lights of the plant assemblies 300. This power is used by the secondary hub 200 to power and control its functions including the HVAC system 220 and the HVAC controller 222. The HVAC controller 222 may be native to the HVAC equipment and may include the native HVAC controls. Sensors 230 communicate with the HVAC controller 222, which in turn communicates with the primary hub 100 which controls the HVAC temperature and humidity setpoints. In response to the sensor data, the HVAC controller natively makes the necessary adjustments to temperature and humidity through the HVAC system and dehumidifier. The power to the distribution wall 400 powers the water pump 422 and passes through the distribution wall 400 to the associated plant assemblies 300 for powering their lights through connections on the distribution wall such as outlets at each plant assembly 300.

The data line 501 likewise runs with the supply line bundle 500 from the primary hub 100 with branches 531 to each of the plant growth modules 600. The data line 501 can provide two way flow of data. For example, the data line may provide operating control information from the primary hub 100 to the secondary hub 200. The data line 501 may transmit sensor data from the sensors in the plant growth modules 600 to the primary hub 100.

Different plant growth modules 600 may have different light timing cycles. The light timing cycles are controlled by the primary hub 100, according to information and/or instruction provided by an operator. For example, the primary hub 100 may direct the power control panel at the secondary hub 200, which in turn controls the electrical relays to turn the lights on and off at the prescribed time. In the same way, the primary hub 100 controls all other components of the plant growth module 600, such as the pumps, dehumidifier, and HVAC system, through connection to the automation control panel.

The supply lines 502 and power lines 503 and data lines 501 used for distribution of supplies may include pipes and other tubes, electrical lines, cables, and/or data lines, for example. The valves which may be used in various embodiments includes solenoid valves, for example, or other valves which may be automated. The data lines may be coaxial cable, fiber optic cable, or other data transmitting lines, as well as wireless communication such as Wi-Fi, Bluetooth, or cellular communication. In other embodiments, one or more of the valves may be manually controlled. In some embodiments, peristaltic pumps may be used. The HVAC supply lines may include ducts such as duct socks or fabric ducts, nozzles, and/or blowers to direct and control air flow and delivery.

The distribution wall 400 may be an elongated vertical structure extending between the adjacent proximal ends of the associated plant assemblies 300. In some embodiments, the distribution wall 400 may be a wall like structure in which the supply lines 430 and power distribution lines are enclosed, with spaced connecters provided at intervals for connection to each plant assembly 300 on each side of the distribution wall 400 facing the plant assemblies 300. In other embodiments, the distribution wall 400 may be an open sided system of supports such as a rack system for supporting supply lines 430 with spaced connectors for each plant assembly 300 on each side of the rack. Other physical forms of distribution structures are also possible.

FIG. 4 is an example of a distribution wall 400 according to various embodiments. The distribution wall 400 is located adjacent to the secondary hub 200, extending away from the secondary hub 200 between two columns of six plant assemblies 300 each which are shown as representative rectangular blocks for ease of depiction. Note, however, the column of plant assemblies 300 closest to the viewer are not shown in order to reveal the details of the distribution wall 400 and secondary hub 200.

The distribution wall 400 of FIG. 4 includes an outer frame 402 which supports an upper support shelf 404 and a lower support shelf 406. Alternative embodiments could include a single shelf or more than two shelves. The support shelves 404 406 extend along the length of the distribution wall 400, past each of the plant assemblies 300. The support shelves 404 406 may be solid or may be an open grid material such as a basket. In some embodiments, one support shelf may be a wet shelf while the other support shelf may be a dry shelf or a power shelf. In the embodiment shown, the upper shelf 404 is a wet shelf and supports the supply lines 430 (not shown) which extends along the length of the upper shelf 404, from the irrigation manifold 426 (not shown), with two supply lines 430 extending to each location of the proximal end of each plant assembly 300 where they terminate in a supply line connector. Each supply line connector connects to an irrigation line (not shown) which extends across the top of the plant assembly 300, over one of the root wells 322 on one side of the plant assembly 300 as described further below. A pair of supply line connectors are located at the location of the nearest end of each plant assembly 300, for easy connection and disconnection of the plant assembly 300 from the distribution wall, to allow the plant assembly 300 to be moved away from the distribution wall 400. A water return line 428 (not shown) runs from each of the plant assemblies 300 to a water return connector at the distribution wall 400 to the connect the water return line 428 to the distribution wall 400 to return water to the distribution tank 420. Examples of supply line connectors and return line connectors which may be used in various embodiments include valves which may turned off prior to disconnection and opened after connection. Connectors provided on each side of the distribution wall 400 at the location of each plant assembly 300 may include connectors such as quick disconnect fittings, hard piping, bulkheads flexible tubing, valves and/or other appropriate connectors. The distribution wall 400 may further include outlets on each side of the distribution wall at the locations of each plant assembly 300. Each outlet may supply power to the lights of the associated plant assembly 300, with power supplied to the lights in a serial, daisy-chained fashion, for example. Appropriate outlets may be provided for the native voltage of the country in which the system 10 is used.

In the embodiment shown, the lower shelf 406 is a dry shelf. The power output lines (not shown) extend along the length of the lower shelf 406, from the secondary hub 200 and extending from the first plant assemblies 300 to the last plant assembly 300 in the columns, and includes a plurality of connectors, one for each plant assembly 300. One power output line connector is located at the location of the nearest end of each plant assembly 300. In this way, the distribution wall 400 provides an easy and accessible method of quickly connecting and disconnecting each of the plant assemblies 300 to water and nutrition supply and return lines and to a power supply.

The distribution wall 400 further includes an HVAC duct 424 (not shown) which extends along the length of the distribution wall 400 to the outermost plant assembly 300 and provides temperature and humidity controlled air to the plant assemblies 300. The HVAC duct 424 may be an air plenum or other duct and may include a plurality of vents or other opening or connections, such as one vent at the location of the near end of each plant assembly 300 or between the near ends of the plant assemblies 300, to supply temperature, humidity, and carbon dioxide controlled air around each plant assembly 300, under the operation of secondary hub 200 as directed and controlled by the primary hub 100.

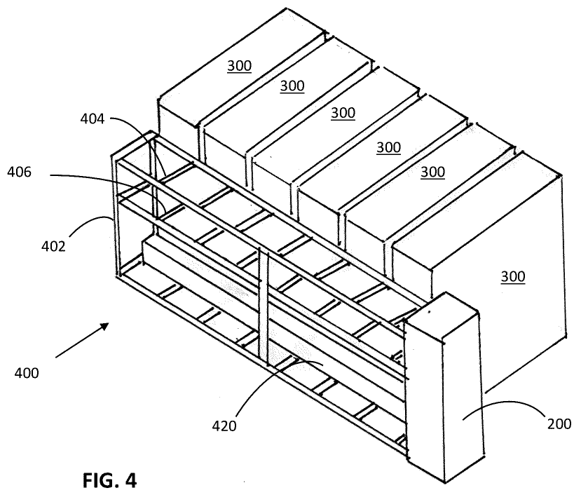

FIG. 5 shows an alternative embodiment of a distribution wall 400. As in FIG. 4, the plant assemblies 300 are represented by rectangles for ease of depiction, with the column of plant assemblies nearest the viewer not shown in order to reveal the side of the distribution wall 400. Likewise the distribution wall 400 is represented by a rectangle, with the connection points not shown. In this example, the water and nutrients are supplied from the distribution tank 420 through the supply lines 430 to each of the plant assemblies 300. Connections are provided as access ports on both sides of distribution wall 400 at each plant assembly 300 for easy connection and disconnection of each plant assembly 300 to its pair of water supply lines 430, water return lines 428 and power supply. In addition, an HVAC duct 424 extends from the secondary hub 200, above the distribution wall 400′ and along the length of the distribution wall 400′ with vents (not shown) at each plant assembly 300.

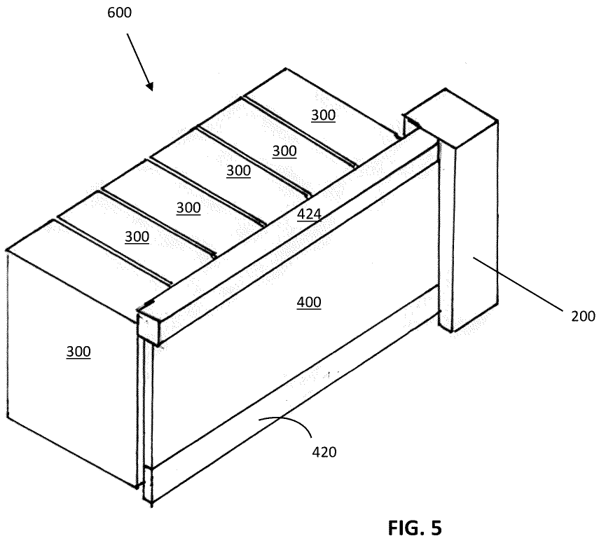

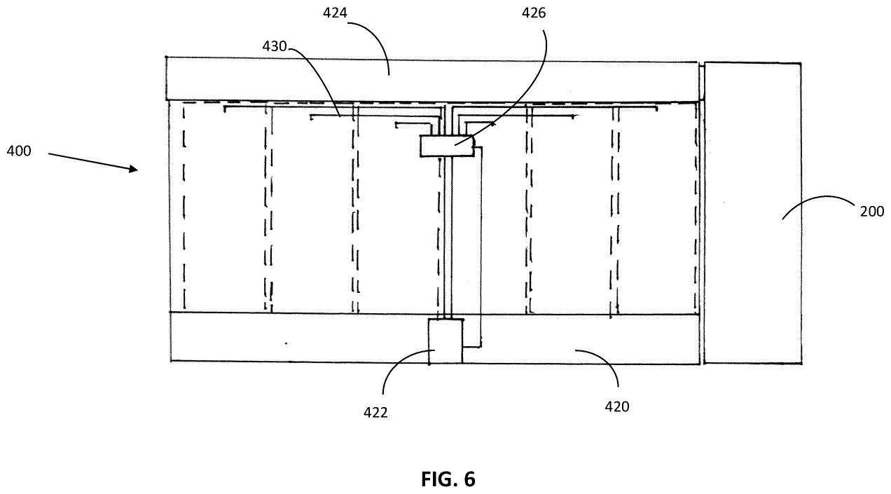

FIG. 6 is a representative drawing of a distribution wall 400 according to various embodiments. One end of the distribution wall 400 is immediately adjacent to or abuts the secondary hub 200. A pump 422, such as a sump or inline pump, is located within the distribution wall 400 to pump water from the distribution tank 420 within the distribution wall 400 to the water supply lines 430 to supply water and nutrients to the plant assemblies 300. An irrigation manifold 426 at the top of the distribution wall 400′ separates the water pumped by the pump 422 into a plurality of different supply lines 430. Water is supplied from the irrigation manifold 426 along supply lines 430 for connection to irrigation lines to each of the plant assemblies 300. In some embodiments, the water supply may be split to the various water supply lines through a plurality of manifolds.

The modular plant wall system 10 can be used to deliver a controlled and individualized supply of water, nutrients, and power to any form of a plant assembly 300 in which a plurality of individual plants are grown on a support such as a vertical support. In the embodiments described herein, the plant assemblies 300 include vertically oriented plant walls with supports for a plurality of plants. However, various other plant assemblies 300 could be used, including assemblies which are not vertically oriented, and would benefit from the primary and secondary hub system 10 described herein.

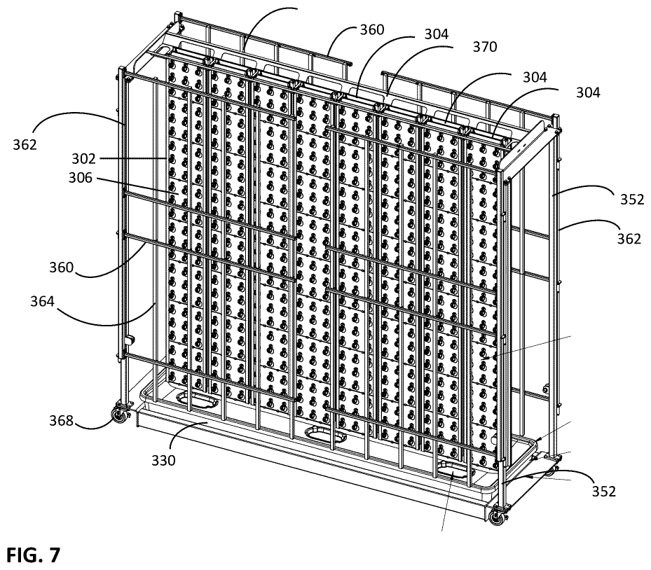

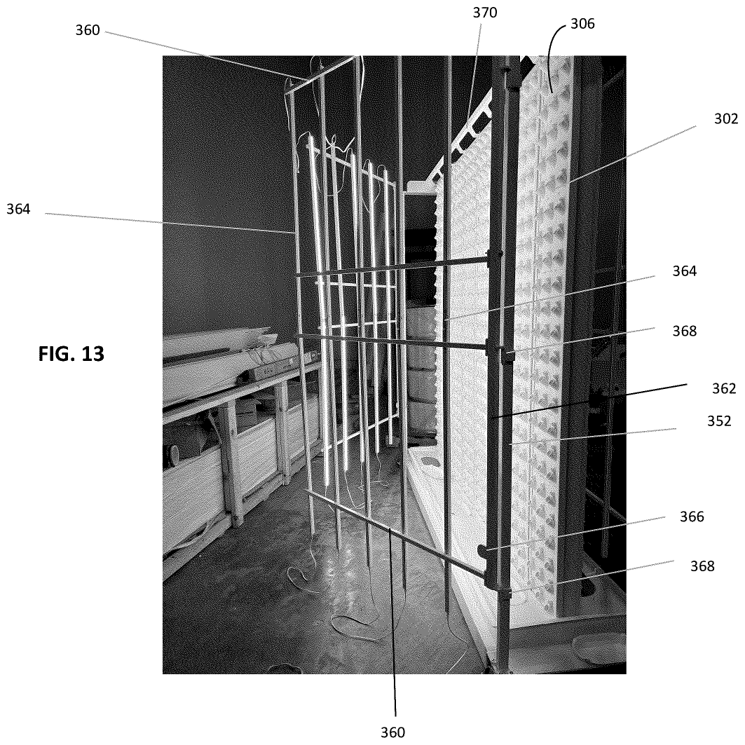

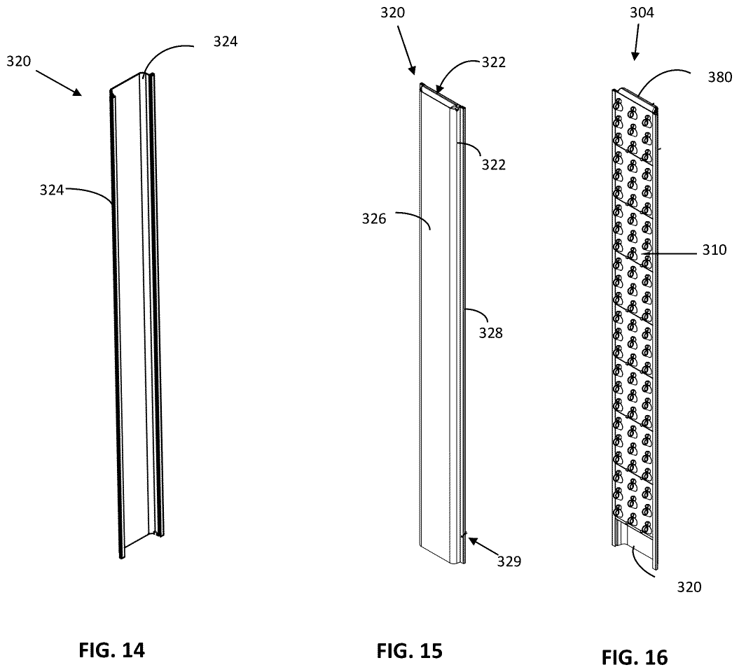

In some embodiments, the plant assembly 300 is a vertical wall type structure providing a vertically oriented array of supports for individual plants dispersed across both sides of the wall, with water and nutrients provided at the top of the wall and flowing down to the plants by gravity. One example of such a plant assembly 300 is shown in FIG. 7. The plant assembly 300 includes a vertical plant wall 302 including a plurality of plant columns 304 arranged side by side and forming a plant wall first side 306 and an opposing plant wall second side 308 (not shown). As shown in FIGS. 14-17, each plant column 304 includes a plurality of vertically stacked plant panels 310 in a single column held by a U-shaped support 320 which hold the plant panels 310 at their lateral edges and encloses the backs of the plant panels, forming a gap which may be referred to as a root chamber 322 between the plant panels 310 and the support 320. As shown in FIGS. 18 and 19, each plant panel 310 includes an array of plant wells 312 that are formed by apertures 314 extending through the plant panel 310 and projections 316 that project outward beneath the apertures 314 to directly support individual plants, or alternatively may include projection inserts that insert into the apertures 314 to hold the individual plants. The individual plants and/or their roots extend through the apertures 314 with the root ends of the plants located in the root chamber 322. In some embodiments, each aperture 314 is associated with a smaller second aperture directly adjacent to it, such as directly above it and abutting it, which may be used to hold a plant support element such as a trellising stake. Each of the plant wall first side 306 and second side 308 are made of a plurality of plant columns 304 arranged side-by-side, with the plant panels 310 facing outward on each side. The supports 320 of the first and second sides 306 308 are within the interior of the plant wall 302 and are back-to-back in an abutting arrangement. As such, the root chamber 322 of the first side 306 is separated from the root chamber 322 of the second side 308 by the backs 324 of the supports 320. However, in alternative embodiments, the plant panels 310 of the first and second sides 306 308 could be spaced apart without being separated by the support 320, with the gap between the panels 310 forming a single root chamber, with water flowing behind and down the back of the plant panels 310 in the root chamber. Other configurations of plant walls systems could alternatively be used.

A pair of irrigation lines, not shown, which may be a perforated hose or other tubing, are supplied with water, nutrients and buffer by supply lines 430 in the distribution wall 400. The irrigation lines extend across the top of the plant wall 302, along the length of the wall 302, one over the root chamber 322 of the first side 306 and the other over the root chamber 322 of the second side 308. The irrigation lines include a plurality of apertures spaced along the irrigation line which allow water, and the nutrients and buffer in the water, to flow out of the irrigation line and into the root chambers 322, where the water flows down under the force of gravity, over and/or around the plant roots. A reservoir 330 extends beneath the entire plant wall 302. The reservoir 330 includes a cover 340 which extends over the reservoir 330 and includes apertures 344 into which the bottom ends of the supports 320 are inserted, such that water passes though the root chambers 322 and into the reservoir 330 through the apertures 344.

The water collected in the reservoir 330 of each plant assembly 300 is returned to the distribution tank 420 though their water return lines 428. Water return lines 428 connect to the proximal end of the reservoir 330 adjacent to the distribution wall 400 at the aperture 332 in the side wall of the reservoir 330. Water flows passively by gravity back through the water return line 428 back to the distribution tank 420. As such, a single pump 422 located in the distribution wall 400 pumps water from distribution tank 420 to the tops of each of the plurality of plant growth assemblies 300 in the plant growth module 600, where it flows through each plant assembly 300 into its reservoir 330 and then passively into the centrally located distribution tank 420. There is no pump in the reservoir 330 or elsewhere in the plant assembly 300. The distribution wall 400 allows for a centralized source of regulated water and nutrients for all plant assemblies 300 in the plant growth module 600, with water circulation to all plant assemblies 300 by a single pump, for a more efficient system that is easier to maintain.

The plant wall 302 and the reservoir 330 are supported by a rectangular frame 350 that surrounds the wall 302 and supports the reservoir 330 at its sides and below. The frame 350 includes a plurality of vertical and horizontal bars, which may be metal bars to provide strength or other appropriate strong material. In this embodiment, the frame 350 includes four vertical end bars 352 at each side end (vertical corner) of the frame 350. The frame 350 further includes a first side 356 which extends across the first side 306 of the plant wall 302 and a second side 358 which extends across the second side 308 of the plant wall 302.

Each of the first and second sides 356 358 of the frame 350 are made of two separate halves which each comprise a plurality of horizontal bars 360 attached to a vertical bar 362 at the outer ends of the horizontal bars 360. The vertical bars 362 which each support the plurality of horizontal bars 360 are directly adjacent to the vertical end bars 352 at the ends of the frame 360. The horizontal bars 360 of each half of the first side 356 together extend across the first side 306 of the plant wall 302 but are disconnected in the middle with a small gap between them. Likewise the horizontal bars 360 of each half of the second side 358 together extend across the full second side 308 of the plant wall 302 but are disconnected in the middle. Alternatively the horizontal bars 360 could abut at the center or overlap or could be further spaced apart. Furthermore, in the embodiment shown, the horizontal bars 360 of each half of the first and second sides 356 358 are in alignment, but such alignment is not necessary, and other numbers, spacing or arrangement of horizontal bars 330 could be used. Furthermore, the first and second sides could optionally include other bars such as additional vertical bars, or some or all of the bars might not be horizontal.

Each of the two halves of the first and second sides 356, 358 are connected to the frame 350 only at the vertical end bars 352 at the ends of the plant wall 302. The connection between the vertical bars 362 and the vertical end bars 352 is a swinging connection such as a hinge 368 or pin. In this way, the connection between each half of the first and second sides 356 358 of the frame 350 allow the halves to swing open, away from the plant wall 302 like doors, exposing and providing access to the first and second sides 306 308 of the plant wall 302. Other configurations of bars are possible in which each half of the side 306 308 is separate or separable in the middle and has a swinging connection to provide access to the plant wall 302. In alternative embodiments, the two halves of each of the first and second sides 356 358 could be detachably connected at the center such as by a clasp which could be manually disconnected as needed to allow the two halves to swing open.

In the embodiment shown, the frame 350 includes magnets 366 to hold the “doors” in a closed configuration. Matching pairs of magnets 366 are located in alignment on the vertical end bars 352 and the vertical bars 362 of the doors to gently hold the two halves of the first and second sides 356 358 in a closed configuration, parallel to the outside face of the plant wall 302.

FIG. 13 shows a photograph of a plant assembly 300 with the lights of the light strips 364 illuminating the first side 306 of the plant wall 302. The two halves of the first side 356 of the frame 350 are partially open. The second side 308 of the plant wall is dark, with the light strips 364 on the second side 358 of the frame 350 unlit.

The frame further includes an upper support 370 including a pair of parallel horizontal bars 372 extending across the length of the frame 350 at the top of the frame 350 with adjoining strips 374 extending along the horizontal bars 372 and angled downward and inward from the horizontal bars 372. At the lower edges of the strips 374, a plurality of crossbars 376 connect the two strips 374. A gap between the strips 374 forms an aperture 378 with the crossbars 378 between them and separating them. The upper end of each plant column 304 is held in position in the frame 350 by upper support 370, with the upper end of the pair of back to back plant columns 304 positioned and held in an upright position within the aperture 378. In addition, the strips 374 include notches 379 adjacent to each of the gaps.

The horizontal bars 360 of the first and second sides 356 358 of the frame 350 support a plurality of lights. In the embodiment shown, there are three pairs of horizontal bars 360 on each half of each side 356 358, but there could alternatively be more or fewer, as desired, and the supports need not be horizontal and need not be bars, though they preferably provide ample open space to allow the passage of reflected light between them as described further below. The horizontal bars 360 support the array of lights which attach to the horizontal bars 360 to shine directly inward toward the plant wall sides 306 308. In the example shown, the array of lights is a plurality of evenly spaced vertical light strips 364, removably attached to the inside of the horizontal bars 360, such as by clips or clamps, and supported by the horizontal bars 360, though other configurations of supports and/or lights are possible. Power is supplied to the plurality of lights through the distribution wall 400, with the light cycle controlled by the primary hub 100, with the light cycle of each plant growth module separately controlled.

The array of lights may be provided by a plurality of light strips 364. The plurality of individual lights in each light strip 364 are closely spaced and are oriented inward, to shine light toward the first and second sides 306 308 of the wall 302. The lights may be LED, HID, metal halide, or high pressure sodium, for example, and the specific type of light may be selected depending upon the type of plant which is being grown in the plant assembly 300. Any configuration of a plurality of individual lights may be used, such as a horizontal or a vertical array or any other configuration of evenly spaced individual light sources.

The horizontal bars 360 of the first and second sides 356 358 of the frame 350 extend across nearly one half of the wall 302, in a spaced and stacked configuration, to provide support for the light strips 364 in an evenly spaced manner across the first and second sides 306 308 of the plant wall 302. The swinging connection between each half of the first and second side 356 358 of the frame 350 allows the halves to swing outward, away from the wall 302, like a door. As such, all of the vertical light strips 364 are connected to the frame 350 by a hinged type of support, with the vertical light strips 332 provided on four mobile door-like supports provided by the horizontal bars 360 or other configuration of swinging bar supports. In this way, an operator can swing the hinged light supports structure “doors” outward to access the front and back sides 304 306 of the plant wall 302, and the plants they contain, more easily. Although not shown, it should be understood that power is supplied to the light strips 364 through electrical lines, such as electrical lines running on or within the components of the frame 320, which may pass from one light strip 364 to the next around the entire plant assembly 300.

In various embodiments, the plant assemblies 300 may be configured to maximize the amount of light provided to the plants for a particular amount of energy. In this way, the energy costs of plant production are minimized while optimizing plant growth. Several variables may be optimized, independently or in combination, to optimize energy use and plant growth.

The frame 350 support for the lights strips 364, which is this example is the horizontal bars 360 with attachment points, are configured such that the lights are equally spaced away from the outer surface of the plant panels 310 by a distance x. For example, for leafy green plants the distance x may be between about 10 and about 14 inches, while for fruiting crops x may be between about 12 and about 30 inches. In some embodiments, the energy usage is minimized by optimizing the distance x between the light sources and the plants, as well as the distance between the sides 304, 306 of separate, adjacent plant walls 302 in adjacent plant assemblies 300. The outer surface of the plant panels 310 of sides 304 306 of the walls 302 may be a reflective material or color such as white. The white color may be selected to maximize reflectiveness. The plant assemblies 300 may be arranged directly side-by-side in an aligned and stacked configuration, with the frames 350 of adjacent plant assemblies 300 abutting each other or virtually abutting each other, such as with the adjacent frames 350 spaced between about 0 and about 6 inches, or between about 0 and about 1 inch, or between about 0 and about 2 inches, or between about 0 and about 3 inches. By closely stacking the plant assemblies 300 close together and employing a reflective surface, the use of the light is maximized for increased energy efficiency. For example, the light of a first plant assembly 300 shines inward from the light array on the frame 350 onto the plants in the plant panels 310 on one side of the plant wall 302. Light that is not absorbed by the plants is reflected outward by the plant panels 310 toward the plants in the directly adjacent second plant assembly 300, where it may be absorbed by the plants of the second plant assembly 300. In this way, light that is not absorbed by the plants of the first plant assembly 300 has a maximum opportunity to be absorbed by plants of an adjacent plant assembly 300 rather than dispersing and being wasted. Likewise, the light directed toward but not absorbed by the plants of the second plant assembly 300 reflects outward, off the surface of the plant panels 310 of the second plant assembly 300 and toward the plants of the first plant assembly 300. In this way, the light is reflected between the plant walls 302 of closely adjacent plant assemblies 300 to maximize the likelihood of absorption by plants and minimize energy waste.

The frame 350 further includes wheels 368 at the bottom of the frame 320 to assist with maneuvering the plant assemblies 300. Because the plant assemblies 300 are arranged in a closely stacked configuration, it is necessary to move the plant assemblies 300 out of alignment in order to swing open the first and second sides 356, 358 to access the plants. This maneuvering of the plant assemblies 300 is assisted by the wheels 368 as well as by the placement of connections between the plant assemblies 300 and the distribution wall 400 at the ends of the plant assemblies 300, with connections that may be quick connect connections. Examples of quick connect connections are camlocks which may be obtained from camlockdirect.com, for example, pressure connection valves, union fittings, as well as other simple manual connect and disconnect types of connections. These allow for a simple and quick disconnection of the plant assemblies 300 from the distribution wall 400. In alternative embodiments, the frame 350 could connect to tracks for maneuvering the plant assemblies, in addition to or as an alternative to wheels. In this way, the plant assemblies 300 can be easily connected to and disconnected from the distribution wall 400 so that the assemblies 300 can be moved out of and back into the stacked configuration, such as by rolling on the wheels 368 or moving on a track or by other means of movement.

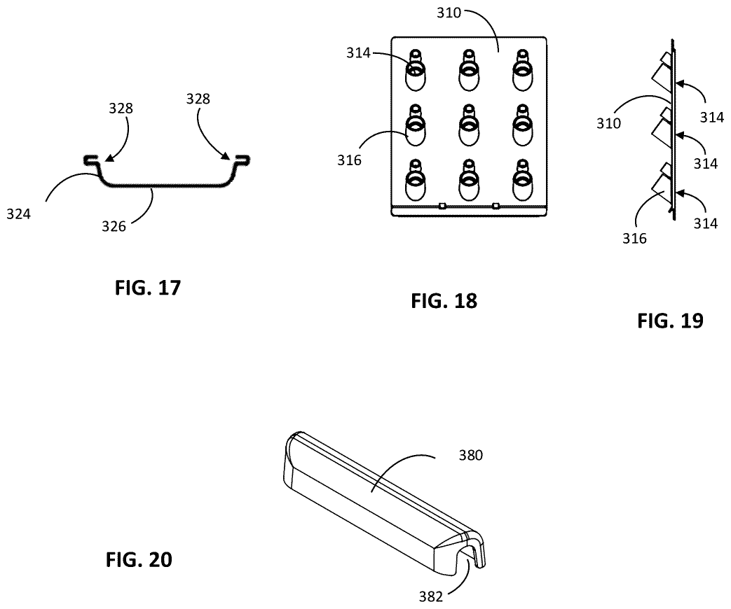

The plant walls 302 include plant columns 304 arranged side by side. The plant columns 304 include an elongated and U-shaped support 320 which holds a plurality of plant panels 310 in a stacked configuration. Perspective side views of the support 320 are shown in FIGS. 14 and 15 and an end view of the support 320 is shown in FIG. 17, while a perspective view of the plant column 304 is shown in FIG. 16. The support 320 includes opposing side walls 324 and a back wall 326 extending the length of the support 320 between the side walls 324. The back edges of the side walls 324 connect to or are contiguous with the back wall 326, while the front edges of the side walls 324 are exposed. The front edges of the sidewalls 324 provide a connector to removably connect the support 320 to the plant panels 310. In this embodiment, the connector is formed by the outer edge of the side wall 324 which is folded back onto itself to form a channel 328 which extends from the top to the bottom of the support 320 along each side wall 324.

The channel 326 holds the plant panels 310 in place in the plant column 304. An example of a plant panel 310 is shown in FIGS. 18 and 19. The plant panel 310 can be inserted into the support 320 by positioning the plant panel 310 at the top of the support 320, with the plant wells 312 facing away from the support 320, and with the side edges 314 of the plant panel 310 aligned with the channels 326 at each side of the support. The plant panel 310 can then be slid into the support 320, with the side edges 314 sliding within the channel 328. The plant panel 310 can be slid downward by a user, or can slide downward by the force of gravity, to the bottom of the support 320. Additional plant panels 310 can likewise be slid onto the support 320, sliding down until their bottom edges rest upon the top edge of the plant panel 310 located beneath it on the support 320. Later, at any desired time, the plant panels 310 be removed by sliding them upward, out of the support 320, beginning with the top most plant panel 310, in a reverse of this procedure.

The support 320 may include a stop to prevent the plant panel 310 from sliding out the bottom end of the support 320 and/or to hold the lowest plant panel 310 in the support 320 at a desired position above and spaced apart from the bottom end of the support 320. The stop may be any type of projection against which the bottom edge of the lowest plant panel 310 abuts, preventing the plant panel 310 from sliding lower. In this example, the stop 329 is a rivet which passes through the channel 322 close to but spaced apart from the bottom of the support 320.

FIG. 16 shows the plant column 304 with the support 320 holding the plant panels in a stacked arrangement. The lowest plant panel 310 is spaced above the bottom edge of the support and is held in the position and prevented from sliding lower by gravity by the stop 329. A cap 380 sits at the top of the plant column 304, covering the root chambers 322 between the backs of the plant panels 310 and the back wall 324 of the support 320. The cap 380 is also shown in FIG. 20, in which it can be appreciated that the cap 380 is a dome shaped cover, open at the bottom, and includes openings 382 at each end to allow passage of an irrigation line into the space formed by the cap 380, above the root chamber 322, and then out of the cap 380 and on to the next adjacent plant column 304, with the irrigation lines extending across each consecutive plant column 302 along one side of the plant wall 302.

The plant columns 304 are removably supported in position in the plant assembly 300 by the frame 350 and the reservoir 330. As explained above, the upper support 370 includes apertures 378 which surround and the upper end of the plant columns 304 in vertical position aligned side by side to form the wall 302. Two plant columns 304 are contained within each aperture 378, with the back walls 324 of their supports 320 abutting each other and the plant panels 310 of each column 304 facing outward. The plant columns 304 may be positioned in the upper support 370 by inserting the tops of the plant columns 304 through the apertures 378 from below. In order to accomplish this, the plant columns may need to tilt away from vertical while the plant column 304 is moved upward through the aperture 378. Once the plant column 304 is raised enough to move the lower end of the plant column 304 over its position in the reservoir 330, the plant column 304 may be tilted into a vertical orientation and lowered into position with the bottom of the support 320 resting on the reservoir 330. To remove the plant column 304 from the frame 350, this procedure may be reversed. The angled nature of the strips 374 and the apertures 379 therein allow for tilting the plant columns to facilitate the placement and removal of the plant columns 304 from the frame 350. In addition, the pair of plant columns 304 in back-to-back arrangement can be installed and removed together simultaneously, or they can be installed and removed one at a time.

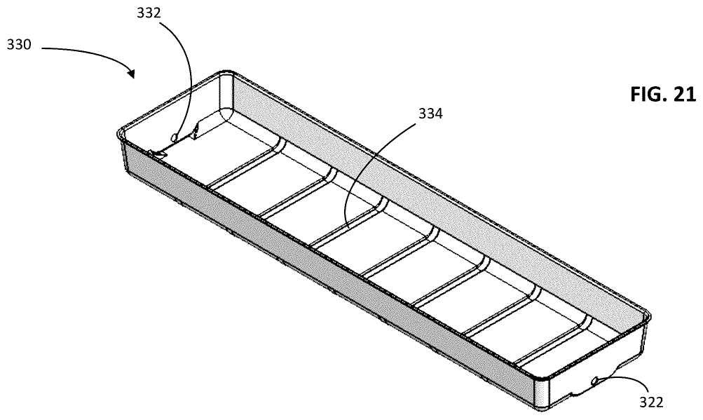

The reservoir 330 is shown in FIG. 21. The reservoir 330 is located at the bottom of the plant assembly 300 and rests on and is supported by the bottom of the frame 350 and crossbars extending across the bottom of the frame 350. The reservoir 330 extends beneath the plant wall 302 and extends across the length and width of the frame 350 to maximize its surface area. The bottom ends of the supports 320 of the plant columns 304 rest on the bottom of the reservoir 330. Therefore, the reservoir 330 and frame 350 must be strong enough to support the water as well as the plant columns 304 and the plants they contain. The bottom ends of the plant columns 304 rest on the bottom of the reservoir. The reservoir 330 supports the weight of the plant columns 304 and the water it contains by resting on a plurality of crossbars 384 which extend across the bottom of the frame 350. A plurality of grooves 334 extend across the bottom of the reservoir 330, and the crossbars 384 fit into the grooves 334 from below, while the plant columns 304 rest on the upward projections produced by the grooves 334 within the reservoir. In this way, the weight of the plant columns 304 is transmitted through the floor of the reservoir 330 directly to the crossbars 384.

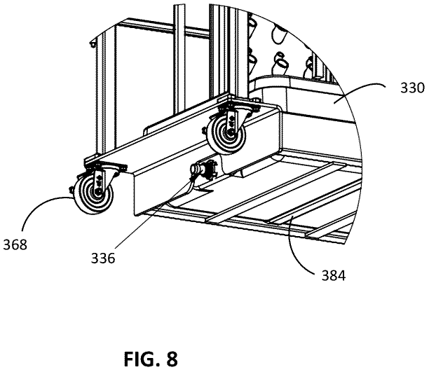

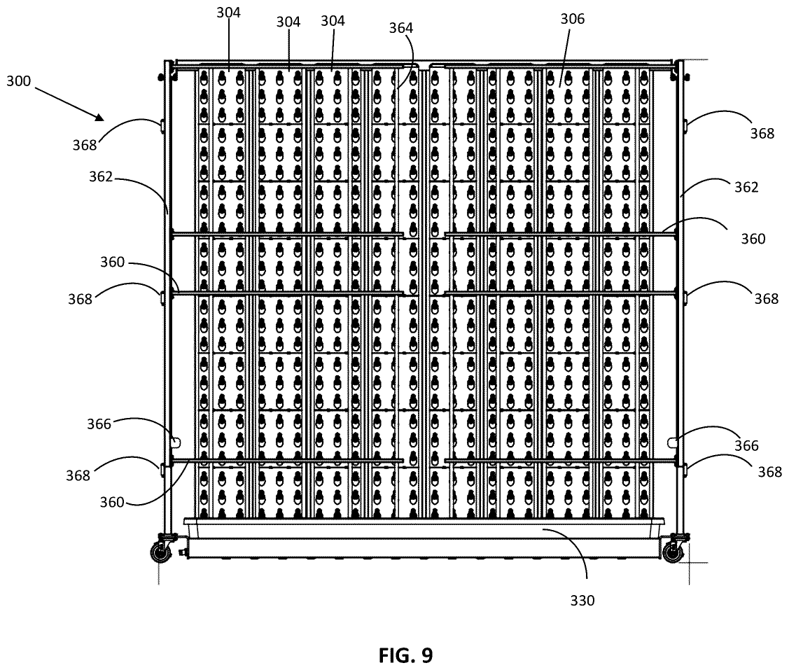

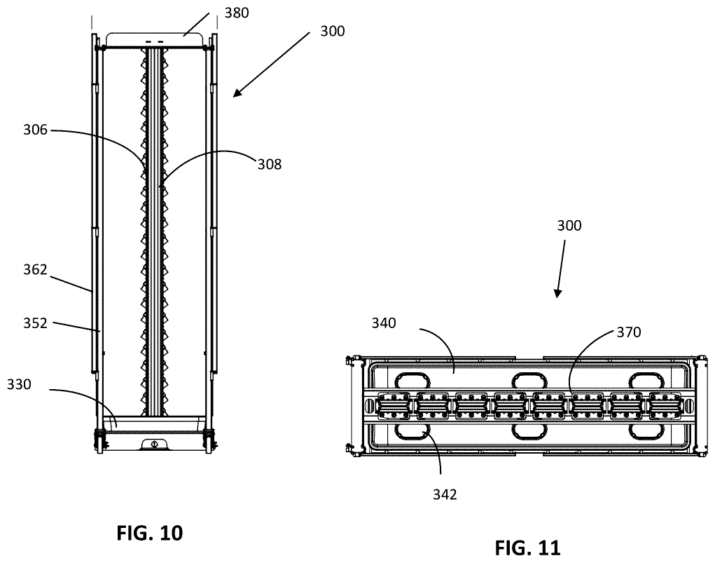

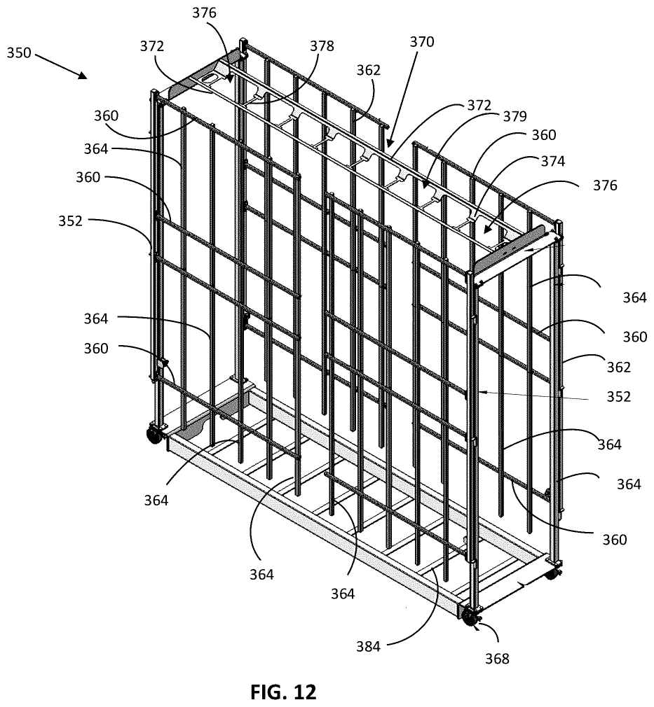

At each end of the reservoir 330 there is an aperture 332 in the reservoir wall, immediately above the bottom of the reservoir 330. As shown in FIG. 8, a bulkhead fitting 336 is located in the aperture for the return water line. The aperture 332 may also include a filter. The aperture 332 at the end of the plant assembly 300 positioned adjacent to the distribution wall 400 connects to the water return line 428. The aperture 332 at the opposite end of the plant assembly 300 is optional but, when present, allows for flexibility to connect the plant assembly 300 to the distribution wall 400 at either end, or for other uses such as including a drain valve, or connection to a different tank, or to provide flexibility for other future uses.

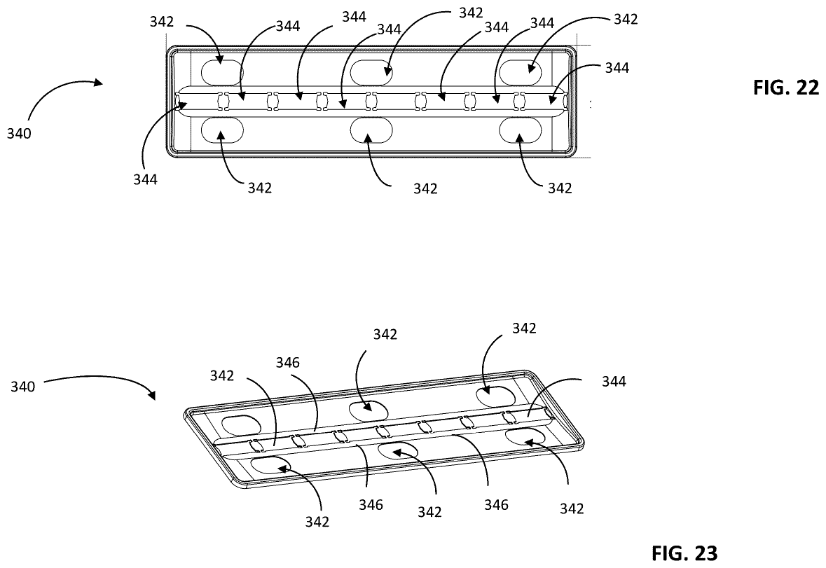

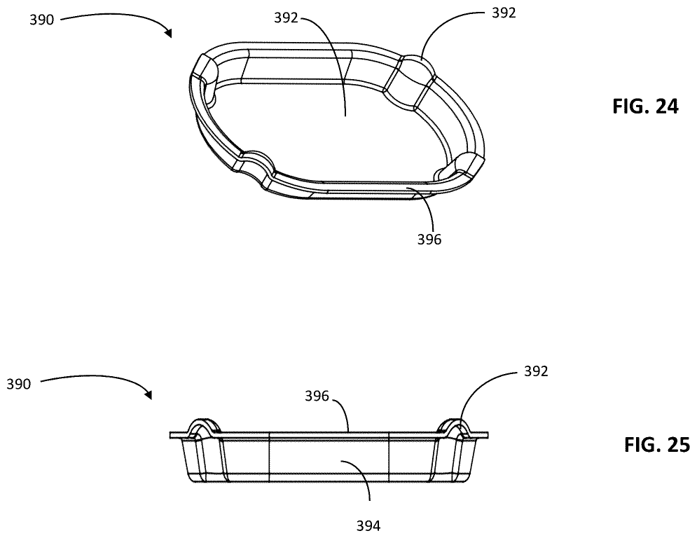

A cover 340 as shown in FIGS. 22 and 23 covers the open top of the reservoir 330. The cover 340 is thin and flat and includes a plurality of apertures. Six access apertures 342 are located around the periphery, though more or fewer access apertures 342 may alternatively be used. The access apertures 342 may be covered by removable plugs, such as plug 390 shown in FIGS. 24 and 25. The recessed portion 392 of plug 390 fits within and covers the access aperture 342 while semicircular elevations 394 in the channel 396 allow for insertion of a fingertip or other tool for easier removal of the plug 390. The access apertures 342 provide access to the interior space of the reservoir 340 and may be used for accessing the interior space of reservoir 340, such as for cleaning out debris.

The cover 340 also includes a plurality of support apertures 344 in a row extending across the length of the cover 340 at the midline. Each of the support apertures 344 are sized and shaped to accommodate one pair of plant columns 304, in back-to-back configuration, as a component of the plant wall 302. The bottom ends of the supports 320 extend through the cover 340 to rest on the reservoir 330, while the plant panels 310 do not. The plant panels 310 terminate immediately above the cover 340, at the level of the cover 340, due to the stop 329 which is positioned in the supports at the level of the cover to align the bottom of the lowermost plant panel with the top of the cover. A recessed portion 346 of the cover 340 extends along the midline of the cover 340 and surrounds the support apertures 344. This recessed shape allows the water to naturally flow toward the center of the cover 340 and through the support apertures 344 and into the reservoir 330.

In the foregoing description various embodiments of the invention have been presented for the purpose of illustration and description. They are not intended to be exhaustive or to limit the invention to the precise form disclosed. Obvious modifications or variations are possible in light of the above teachings. The embodiments were chosen and described to provide illustrations of the principals of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth they are fairly, legally, and equitably entitled.

What is claimed is:

1. An automated plant production system comprising:
a primary control hub comprising a controller;
a plurality of plant growth modules, each plant growth module comprising:
a secondary hub in communication with and controlled by the primary hub,
a plurality of plant assemblies, each configured for growing a plurality of individual plants, and
a distribution tank in fluid connection with each of the plant assemblies;
a plurality of supply tanks, each supply tank containing a supply to support plant growth; and
a plurality of supply lines, each supply line connecting one supply tank to the distribution tank of each of the plurality of plant growth modules;
wherein the primary hub separately controls delivery of each of the supplies to each of the plurality of plant growth modules.

2. The system of claim 1 wherein the supplies comprise water, nutrient, and buffer.

3. The system of claim 1 wherein the plant assemblies comprise hydroponic plant assemblies for growing a plurality of plants in separate wells and an array of lights.

4. The system of claim 3 wherein the plant assemblies comprise vertical walls.

5. The system of claim 3 wherein a light cycle of the plant assemblies in each plant growth module is separately controlled by the primary hub.

6. The system of claim 1 wherein the plant growth module further comprises a distribution wall, wherein the distribution tank is located in the distribution wall, the distribution wall providing connectors to each of the plurality of plant assemblies for a flow of water from the distribution tank to the plant assemblies and back to the distribution tank.

7. The system of claim 5 further comprising a power supply line connecting to each of the plurality of plant growth modules, wherein the distribution wall further provides a power connector for each of the plurality of plant assemblies.

8. The system of claim 7 wherein the plant assemblies comprise vertical walls with plant wells on each side of the wall and an array of lights projecting light onto each side of the wall, wherein the plant assemblies are arranged in a directly adjacent side-by-side stacked configuration on each side of the distribution wall when connected to the water and power connectors of the distribution wall.

9. The system of claim 6 wherein each secondary hub comprises a dehumidifier and an HVAC system comprising a heat pump, and wherein the distribution wall includes a duct with vents to supply air to each of the plant assemblies.

10. The system of claim 7 wherein each plant assembly further comprises a temperature sensor in data communication with the secondary hub, and wherein the primary hub is configured to separately direct each secondary hub to maintain a temperature.

11. The system of claim 1 further comprising a plurality of pumps for the supplies in the supply lines and a plurality of valves, wherein the primary hub separately controls the delivery of the supplies to each of the plant growth modules by opening and closing the valves.

12. An automated system for plant production comprising:
a primary control hub, the primary control hub comprising a controller and a water testing device;
a plurality of plant growth modules, each plant growth module comprising:
a secondary hub in communication with and controlled by the primary hub,
a plurality of plant assemblies, each configured for growing a plurality of individual plants, and
a distribution tank in fluid connection with each of the plant assemblies to supply water and nutrients to the plant assemblies;
a plurality of supply tanks comprising a water supply tank, a nutrient supply tank, and a buffer tank;
a plurality of supply lines, each supply line connecting one supply tank of the distribution tanks of each of the plurality of plant growth modules;
a water return line running from each of the plant growth modules to the primary hub to supply return water to the water testing device;
wherein the primary hub separately controls delivery of each of the supplies to each of the plurality of plant growth modules.

13. The system of claim 12 wherein the water testing device comprises a pH testing device, wherein the primary hub is configured to automatically test the pH of the return water from each of the plurality of plant growth modules on a schedule.

14. The system of clam 13 wherein the controller is configured to calculate, for each automatic pH test, the amount of buffer, if any, needed to correct the pH of water in the plant growth module of which the return water was tested.

15. The system of claim 14 further comprising a plurality of valves, wherein the primary hub separately controls the delivery of the supplies to each of the plant growth modules by opening and closing the valves, and wherein the primary hub is configured to automatically deliver the calculated amount of buffer to the plant growth module of which the return water was tested.

16. The system of claim 12 wherein the testing device measures an amount of a nutrient, wherein the primary hub is configured to automatically test the return water from each of the plurality of plant growth modules on a schedule and to calculate the amount of nutrient needed for each plant growth module to maintain the nutrient at a desired level in each plant growth module.

17. The system of claim 12 further comprising a plurality of valves, wherein the primary hub separately controls the delivery of the supplies to each of the plant growth modules by opening and closing the valves, and wherein the primary hub is configured to automatically deliver the calculated amount of nutrient to each plant growth module in need of additional nutrient based upon results of the automatic testing.

18. An automated plant production system comprising:
a primary control hub comprising a controller;
a plurality of plant growth modules, each plant growth module comprising:
a secondary hub in communication with and controlled by the primary hub,
a plurality of plant assemblies, each configured for growing a plurality of individual plants, and
a water distribution tank in fluid connection with each of the plant assemblies;
a plurality of supply tanks comprising a nutrient supply tank, a water supply tank, and a buffer supply tank;
a water supply line connecting the water supply tank to each of the plant growth modules and comprising a water supply valve at each plant growth module;
a nutrient supply line connecting the nutrient supply tank to each of the plant growth modules and comprising a nutrient supply valve each plant growth module;
a buffer supply line connecting the buffer supply tank to each of the plant growth modules and comprising a buffer supply valve at each plant growth module;
wherein the primary hub is configured to separately control each water supply valve, nutrient supply valve, and buffer supply valve to separately regulate the flow of water, nutrient, and buffer to each plant growth module.

19. The system of claim 18 wherein the system further comprises a water return line connecting each plant growth module to the primary hub, the primary hub further comprising a pH testing device and a nutrient testing device configured to receive return water from each plant growth module in the water return line, wherein the primary hub separately regulates the flow of nutrient and buffer to each plant growth module based on results from the pH testing device and the nutrient testing device.

20. The system of claim 18 wherein the water distribution tanks of each plant growth module include a water level sensor in communication with the primary hub, wherein the primary hub is configured to automatically and separately supply water to each plant growth module in response to the water level sensor to maintain a predetermined water level in each water distribution tank.
